(19) United States
(12) Patent Application Publication
(10) Pub. No.: US 2004/0026938 A1
(43) Pub. Date: Feb. 12, 2004

(54) Apparatus for removing ICS from a wafer

(76) Inventor: Volker Junge, Muenchen (DE)

Correspondence Address: HARNESS, DICKEY & PIERCE, P.L.C., P.O.BOX 8910, RESTON, VA, 20195, US

(21) Appl. No.: 10/352,103

(22) Filed: Jan. 28, 2003

(30) Foreign Application Priority Data
Jun. 26, 2002 (DE) 10228555.1

(51) Int. Cl. B25B 7/00

(52) U.S. Cl. 294/2

(57) ABSTRACT

Apparatus for simultaneously removing a number of ICs from a wafer using a number of gripping elements for the individual ICs. The gripping elements are in the form of separate grippers, and the distances between the grippers are variable in fine steps parallel to the plane of the wafer by use of a movement device. It is thus possible to remove ICs of different sizes, in large quantities, using one apparatus.

The present application hereby claims priority under 35 U.S.C. §119 on German patent application number DE 10228555.1 filed Jun. 26, 2002, the entire contents of which are hereby incorporated herein by reference.

### FIELD OF THE INVENTION

The invention generally relates to an apparatus for simultaneously removing a number of ICs from a wafer. Preferably, the ICs are detachably fixed on a mount and are removable from there by use of at least one gripping device having a number of gripping elements for the individual ICs.

### BACKGROUND OF THE INVENTION

An apparatus is disclosed, for example, in U.S. Pat. No. 6,283,693 B. According to this document, a suction head having a large number of suction channels is provided, whose pitch separation is matched to the distance between the ICs on the wafer. Pushing-off needles are arranged so that they are coincident underneath the wafer and largely detach the ICs from their mounting film. The apparatus is suitable only for removing ICs with the same dimensions. Since these govern the grid interval on the wafer and are not standardized, a specific apparatus must be provided for every IC size.

It is also normal to equip a universal apparatus for ICs of different sizes with only one freely positionable gripper, which can be moved from one IC to another by means of its positioning device. Since detachment of the adhesive joint involves a relatively high time penalty, the quantities that can be processed in this case remain low.

### SUMMARY OF THE INVENTION

An embodiment of the invention is based on an object of making it possible to remove different IC sizes using one apparatus.

This object may be achieved by including a configuration of the gripping elements. The configuration of the gripping elements as separate individual grippers and the inclusion of a movement device preferably make it possible to match the gripper separations precisely to the group intervals between the ICs. It is self-evident that, if the separations are very small, the grippers must be correspondingly thin, like needles. The apparatus needs to be converted only whenever it is necessary to process wafers with a different IC size. During the removal process, the gripper separations remain unchanged. The capability to hold a large number of ICs correspondingly increases the quantities which can be processed for separation.

An embodiment of the invention makes it possible to increase the quantities which can be processed to such an extent that the removal of the ICs can be matched to the performance of a further-processing apparatus. For example, in the case of automatic placement machines for printed circuit boards, it is known for multiple placement heads to be used which can hold a large number of components at the same time. An embodiment of the invention makes it possible to pass the large numbers of ICs involved to the placement head in a short time.

An apparatus of another embodiment makes it possible to fix the stationary gripper as a reference gripper, whose position defines the relative position of the gripping device with respect to the wafer.

The pivoting bearing can be implemented with a low level of design complexity.

The linear guide tracks can allow the grippers to be moved without any angle correction.

The gripping device can set to the central gripper with narrow tolerances.

The grippers can be arranged in a compact manner. The star-shaped arrangement of the grippers and guide tracks allows the aspect ratio to remain unchanged as the distances between them change, thus allowing effortless adjustment for different sizes, particularly for square ICs.

The individual drives make it possible to match the gripper positions to different aspect ratios of the ICs.

Certain preferred developments make it possible to considerably reduce the complexity for the drive and for an associated measurement system.

The slides can allow simple implementation of the drive movement for the grippers on all outer surfaces.

The gripping device which can pivot, for example through 180°, can make it possible to transfer the flip chips in a suitable position, for example on a placement head. The flip chips are held by their insulated rear face on the wafer, so that the contacts point upwards. The grippers suck against the contact face of the flip chips and turn them through 180°, so that they can now be gripped by the placement head on the rear face, in order to make it possible to place their contact face onto a substrate.

Another development makes it possible to remove ICs from the wafer at the same time and to pass the previously removed ICs, which have been rotated upward, to the placement head, thus halving the cycle time and making it possible to considerably increase the removal performance.

Further developments make it possible to remove the grippers which project on both sides of the axis by means of a joint drive.

Another development makes it possible to use the same movement device for movement of the needles as for the grippers. A heater, for example, can also be provided in place of a mechanical pushing-off device, reducing the adhesion between the ICs and the mounting film.

A time stagger makes it easier to remove the ICs from their composite form.

### BRIEF DESCRIPTION OF THE DRAWINGS

The invention will be explained in more detail in the following text with reference to exemplary embodiments which are illustrated schematically in the drawings, in which:

FIG. 1 shows a perspective view of an apparatus for removal from a wafer with large ICs by use of three grippers which are arranged in a row,

FIG. 2 shows the apparatus shown in FIG. 1 with small ICs,

FIG. 3 shows a perspective view of another apparatus having grippers arranged in a number of rows, with large ICs,

FIG. 4 shows the apparatus shown in FIG. 3 with small ICs,

FIG. 5 shows a part of the apparatus shown in FIG. 4, in a rotated position,

FIG. 6 shows a modified gripper of another removal apparatus for ICs,

FIG. 7 shows an enlarged detail of the apparatus shown in FIG. 1,

FIG. 8 shows a plan view of a movement device for the grippers shown in FIG. 3,

FIG. 9 shows the movement device as shown in FIG. 8, in a different position,

FIG. 10 shows a plan view of another movement device for the grippers shown in FIG. 3,

FIG. 11 shows the movement device as shown in FIG. 10, in a different position.

### DETAILED DESCRIPTION OF THE PREFERRED EMBODIMENTS

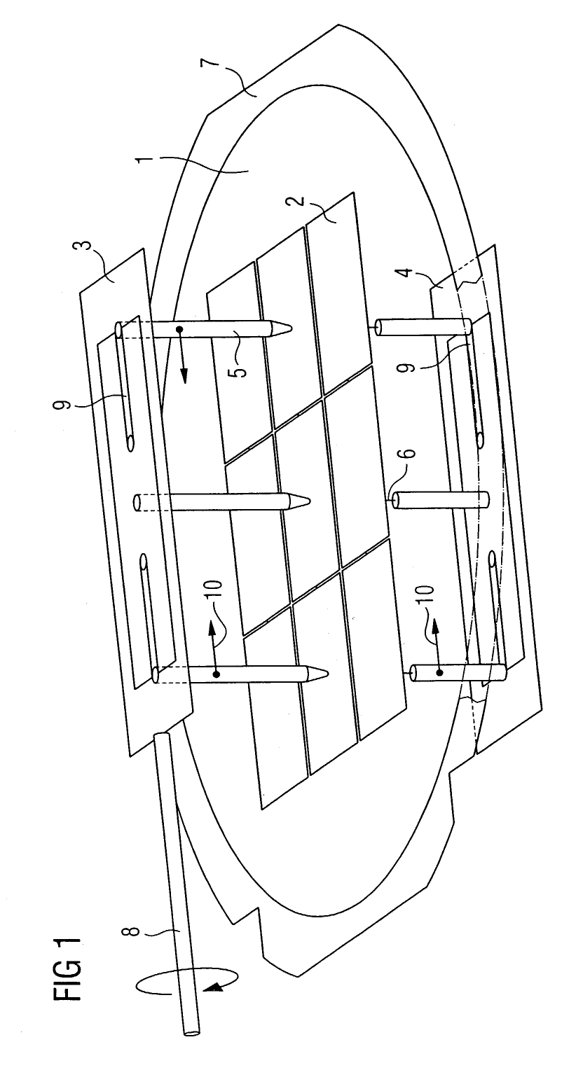

FIG. 1 shows a wafer 1 with relatively large ICs 2. The wafer is held between a gripping device 3 and a pushing-off device 4. The gripping device 3 is provided with three needle-like grippers 5, which point toward the center of three ICs 2 which follow one another in a row. The pushing-off device 4 has pushing-off elements 6 which project toward the grippers 5 and are congruent to them, likewise in the form of needles.

Suction openings in the suction grippers 5 are formed at the tips facing the wafer. These are located a short distance above the upper faces of the ICs, whose lower faces are bonded to a film-like mount. Raising the pushing-off elements 6 raises the associated ICs 2, very largely detaching them from the mount 7 in the process. The suction force of the grippers 5 now holds them firmly, and they are completely detached from the mount 7. The gripping device 3 can be rotated about an axis 8 parallel to the wafer 1. The ICs 2 which have been sucked up can thus be rotated, for example, through 180° upward, from where they are picked up by another handling tool, for example a placement head, in order to be placed on printed circuit boards.

The gripping device 3 as well as the pushing-off device 4 are provided with linear guide tracks 9, which extend in the direction in which the ICs are arranged in a row. The grippers 5 can be moved in the guide tracks by means of drives 10, so that the separation can be adjusted in fine steps for different distances.

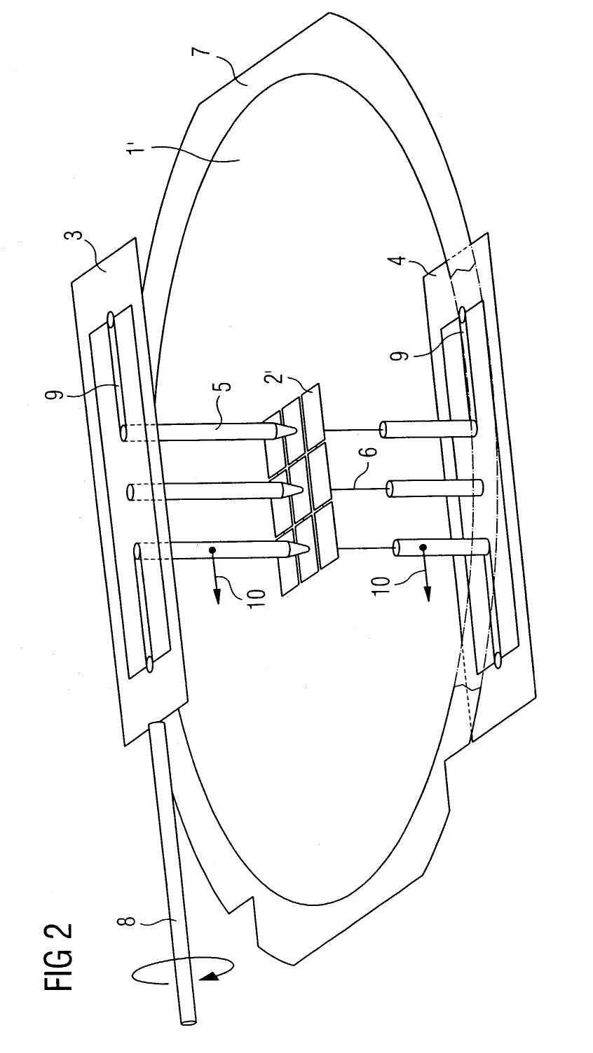

FIG. 1 shows the largest possible separation and FIG. 2 shows the smallest possible separation, as is required for removing correspondingly small ICs 2′. The fine steps in which the drive 10 acts also makes it possible, however, to set any desired other distances between the grippers 5 which correspond to the grid intervals between ICs of different sizes.

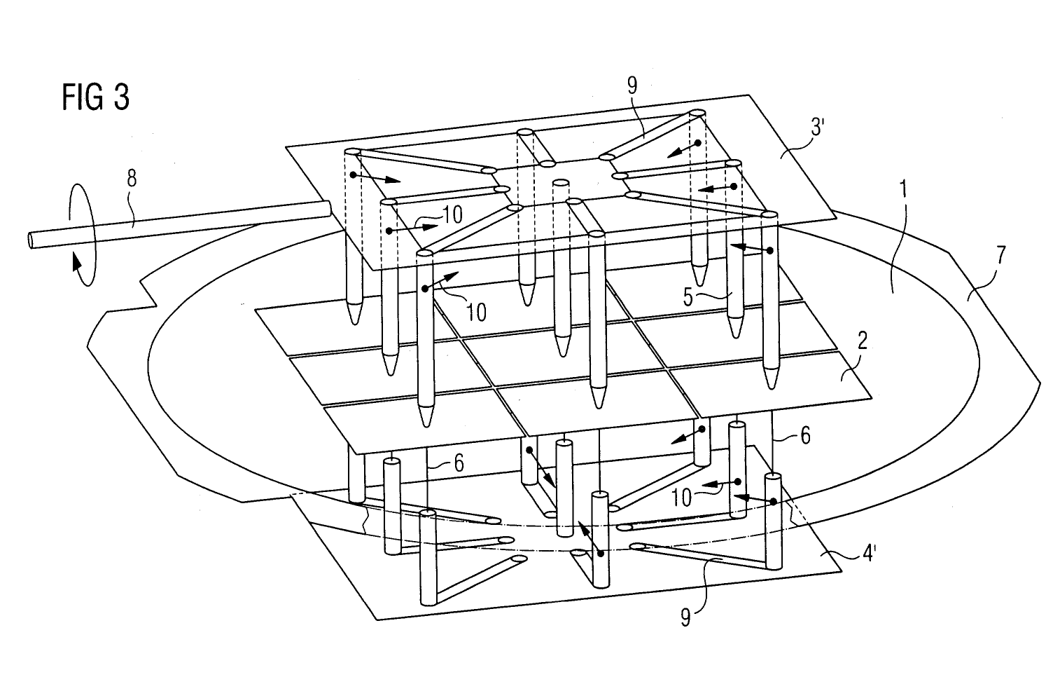

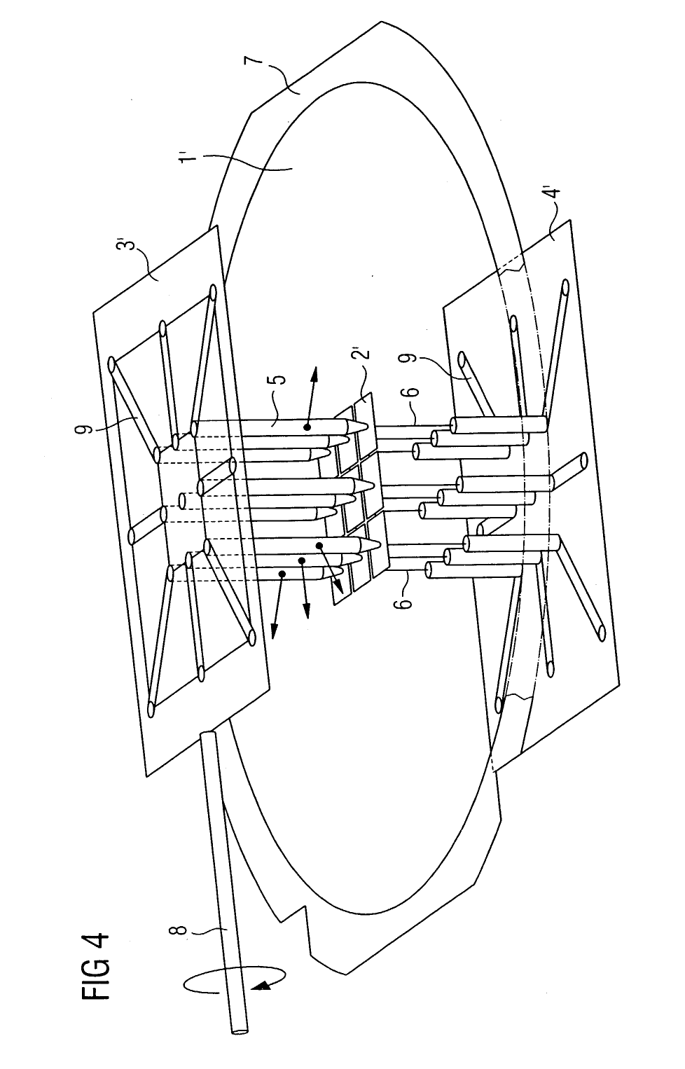

The apparatus shown in FIG. 3 is provided with a modified gripping device 3′ and with a modified pushing-off device 4′. These each have nine grippers 5 and pushing-off elements 6, which are arranged in three rows. The separation is set for the ICs 2 on the wafer 1 as shown in FIG. 1. The central gripper 5 is arranged such that it is stationary in the gripping device 3′, while the outer grippers 5 are guided parallel to the wafer 1 in the guide tracks 9, which point in a star shape toward the central stationary gripper 5, of the gripping device 3′. The pushing-off needles 6 are guided in the same way in guide tracks 9, which are congruent to the guide tracks 9 of the gripping device 3′, of the pushing-off device 4′. The moving grippers 5 and pushing-off elements 6 can be moved continuously variably in the guide tracks by means of the drives 10, and can be set to different grid intervals for different IC types, in which case, analogously to FIG. 2, the apparatus shown in FIG. 4 represents the smallest possible intervals for the smallest possible ICs 2′.

FIG. 5 shows the gripping device 3′ as shown in FIG. 4 after the ICs 2′ have been sucked up and after they have been rotated through 180° about the axis 8. The ICs 2′ which are in the form of flip chips, have thus been moved to a reversed position in comparison to their position in the wafer 1′, in which their connections lie on the lower face, facing the grippers 5. The ICs 2′ can now be removed in sequence by suction grippers 11 of a placement head, and can be placed onto a substrate.

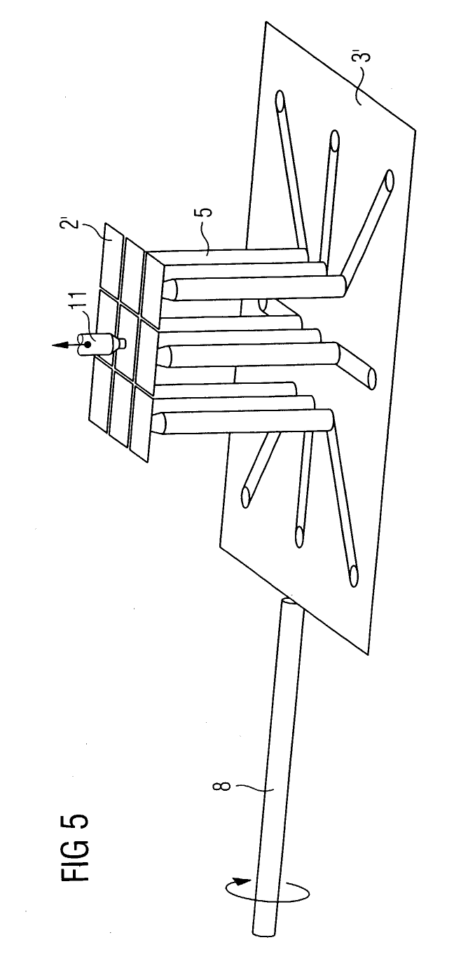

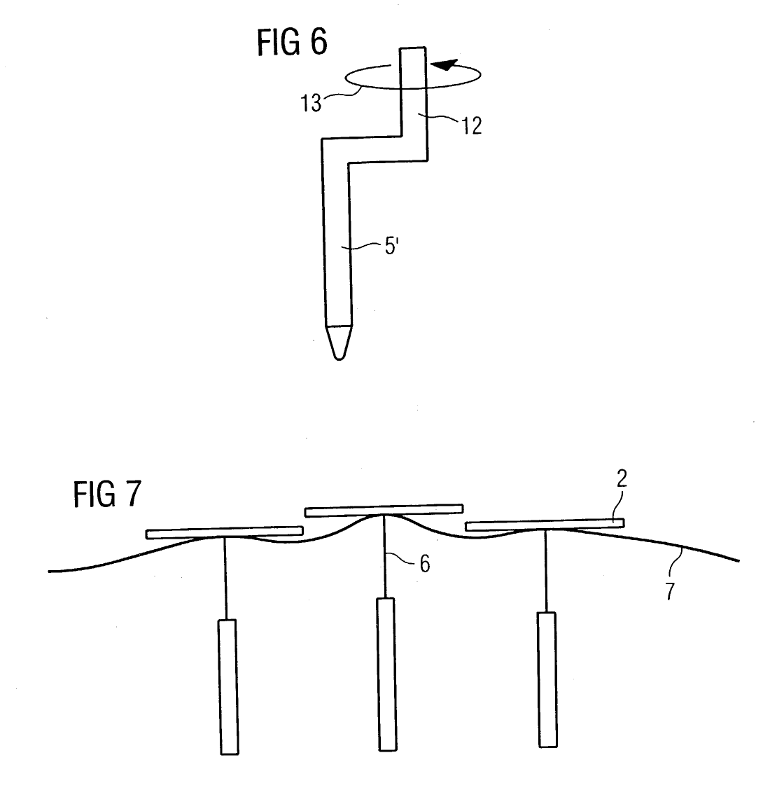

Another gripper 5′ as shown in FIG. 6 has a kinked profile in the manner of a crank, and can be moved by means of a pivoting drive 13 about a pivoting axis 12 at right angles to the wafer. This makes it possible to change the distances between the grippers 5′ of the gripping device in opposite senses and to match them to different chip sizes, although an appropriate angle correction must be carried out for the gripping device.

FIG. 7 shows, schematically, how some of the pushing-off elements 6 can push some elements off the mount 7 ahead of others by means of different lifting drives, so that the corresponding ICs 2 can be removed from the wafer better. The remaining ICs 2 can be removed by subsequently raising the other pushing-off elements 6.

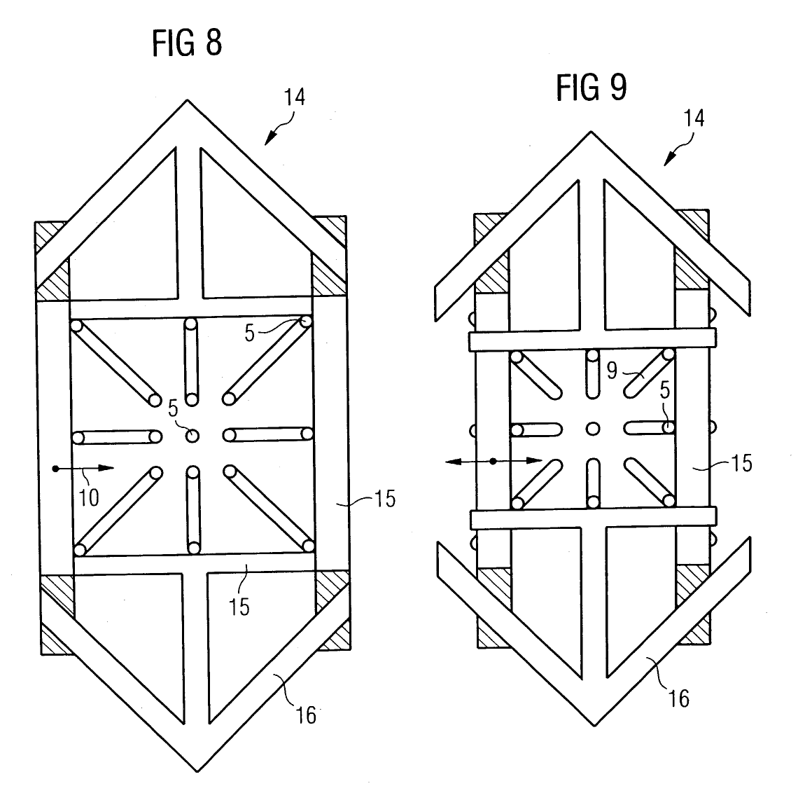

FIGS. 8 and 9 show a schematic plan view of a movement device 14 for the gripping device 3′. In this case, the grippers 5 and, in the same way, the pushing-off elements of the pushing-off device are moved by means of mutually overlapping slides 15, which are applied from the outside and are moved simultaneously and in synchronism by means of a deflection device 16 in a similar manner to a slotted link such that they are always centered on the central stationary gripper 5, as can be seen from a central position shown in FIG. 9.

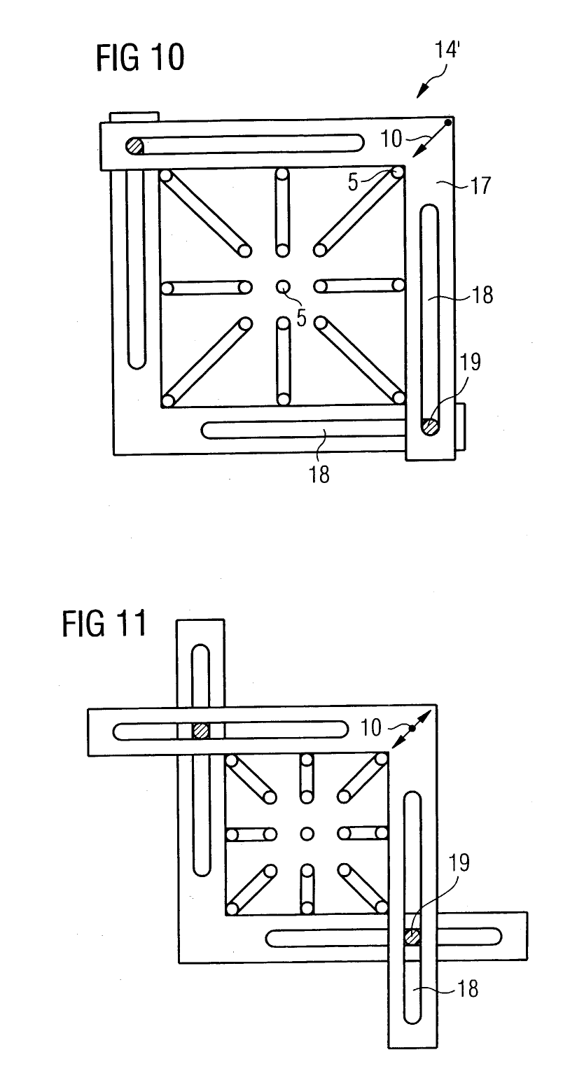

FIGS. 10 and 11 show a modified movement device 14′, in which two angled slides 17 overlap one another like shears at their free ends and are kinematically coupled to one another via guide slots and guide pins 19 such that they enclose a variable active area for the outer grippers 5 by means of the diagonally applied drive 10, with the grippers 5 resting, for example in a sprung manner, on the inner faces of the angled slides 17.

List of symbols

| | |
|---|---|
| 1, 1’ | Wafer |
| 2, 2’ | IC |
| 3, 3’ | Gripping device |
| 4, 4’ | Pushing-off device |
| 5, 5’ | Gripper |
| 6 | Pushing-off elements |
| 7 | Mount |
| 8 | Axis |
| 9 | Guide track |
| 10 | Drive |
| 11 | Suction gripper |
| 12 | Pivoting axis |
| 13 | Pivoting drive |
| 14, 14’ | Movement device |
| 15 | Slide |
| 16 | Deflection device |
| 17 | Angled slide |
| 18 | Guide slot |
| 19 | Guide pin |

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An apparatus for simultaneously removing ICs from a wafer, wherein the ICs are detachably fixed on a mount of the wafer, comprising:
at least one gripping device including a plurality of gripping elements, wherein the gripping elements include separate grippers; and
a movement device, wherein distances between the grippers in the at least one gripping device are variable in fine steps parallel to the plane of the wafer by the movement device.

2. The apparatus as claimed in claim 1, wherein one of the grippers is arranged such that it is stationary in the gripping device, and wherein the other grippers are arranged to be movable.

3. The apparatus as claimed in claim 2, wherein the moveable grippers are mounted in the gripping device to be pivotable about a pivoting axis at right angles to the wafer.

4. The apparatus as claimed in claim 2, wherein the moveable grippers are guided in linear guide tracks in the gripping device.

5. The apparatus as claimed in claim 2, wherein the gripping device includes an odd number of grippers which are arranged in a row, and wherein a central gripper is stationary and outer grippers are moveable.

6. The apparatus as claimed in claim 2, wherein the grippers are arranged in a multi-row matrix in the gripping device.

7. The apparatus as claimed in claim 6, wherein the gripping device includes nine grippers, eight of which are distributed in a rectangle, wherein in the stationary gripper is arranged in the center of the rectangle, and wherein the outer grippers are guided in linear guide tracks which point in the form of a star with respect to the central gripper.

8. The apparatus as claimed in claim 1, wherein the movement device includes individual drives for the individually moveable grippers.

9. The apparatus as claimed in claim 8, wherein a plurality of the moveable grippers are moveable by a joint drive.

10. The apparatus as claimed in claim 9, wherein relatively outer grippers are movable by a single drive, and wherein an actuating movement of the drive is transmittable via kinematic deflection devices to the grippers (5).

11. The apparatus as claimed in claim 10, wherein the deflection devices include slides, fitted to the mutually facing sides of the grippers and centered on the stationary gripper.

12. The apparatus as claimed in claim 1, wherein the gripping device is pivotable about an axis which is parallel to the wafer plane, to a removal position for the ICs which are in the form of flip chips.

13. The apparatus as claimed in claim 12, wherein one group of coincident grippers is arranged on each of the two sides of the axis.

14. The apparatus as claimed in claim 13, wherein the grippers in the two groups are moveable by the joint drive.

15. The apparatus as claimed in claim 1, wherein pushing-off elements, which are complementary to the grippers, of a pushing-off device are provided on the side of the wafer opposite the grippers, the pushing-off elements being moveable via corresponding separate drives in a corresponding manner to the gripper positions.

16. The apparatus as claimed in claim 15, wherein the needles are placed on the flexible mount with a time stagger.

17. The apparatus as claimed in claim 1, wherein at least some of the grippers moveable grippers, mounted in the gripping device to be pivotable about a pivoting axis at right angles to the wafer.

18. The apparatus as claimed in claim 1, wherein at least some of the grippers moveable grippers, guided in linear guide tracks in the gripping device.

19. The apparatus as claimed in claim 5, wherein the gripping device includes three grippers.

20. The apparatus as claimed in claim 3, wherein the grippers are arranged in a multi-row matrix in the gripping device.

21. The apparatus as claimed in claim 4, wherein the grippers are arranged in a multi-row matrix in the gripping device.

22. The apparatus as claimed in claim 20, wherein the gripping device includes nine grippers, eight of which are distributed in a rectangle, wherein in the stationary gripper is arranged in the center of the rectangle, and wherein the outer grippers are guided in linear guide tracks which point in the form of a star with respect to the central gripper.

23. The apparatus as claimed in claim 21, wherein the gripping device includes nine grippers, eight of which are distributed in a rectangle, wherein in the stationary gripper is arranged in the center of the rectangle, and wherein the outer grippers are guided in linear guide tracks which point in the form of a star with respect to the central gripper.

24. The apparatus as claimed in claim 2, wherein the movement device includes individual drives for the individually moveable grippers.

25. The apparatus as claimed in claim 24, wherein a plurality of the moveable grippers are moveable by a joint drive.

26. The apparatus as claimed in claim 25, wherein relatively outer grippers are movable by a single drive, and wherein an actuating movement of the drive is transmittable via kinematic deflection devices to the grippers.

27. The apparatus as claimed in claim 26, wherein the deflection devices include slides, fitted to the mutually facing sides of the grippers and centered on the stationary gripper.

28. The apparatus as claimed in claim 15, wherein pushing-off elements are in the form of needles.

29. The apparatus as claimed in claim 2, wherein pushing-off elements, which are complementary to the grippers, of a pushing-off device are provided on the side of the wafer opposite the grippers, the pushing-off elements being moveable via corresponding separate drives in a corresponding manner to the gripper positions.

30. The apparatus as claimed in claim 29, wherein the needles are placed on the flexible mount with a time stagger.

31. The apparatus as claimed in claim 29, wherein pushing-off elements are in the form of needles.
